(19) United States
(12) Patent Application Publication
(10) Pub. No.: US 2004/0037272 A1
(43) Pub. Date: Feb. 26, 2004

(54) Method of forwarding packet calls in mobile communication system

(75) Inventor: So Hyun Park, Seoul (KR)

Correspondence Address: FLESHNER & KIM, LLP, P.O. BOX 221200, CHANTILLY, VA, 20153, US

(73) Assignee: LG ELECTRONICS INC.

(21) Appl. No.: 10/614,887

(22) Filed: Jul. 9, 2003

(30) Foreign Application Priority Data
Jul. 30, 2002 (KR) 44942/2002
Sep. 13, 2002 (KR) 55628/2002

(51) Int. Cl. H04L 12/66

(52) U.S. Cl. 370/354

(57) ABSTRACT

A system and method forwards packet calls for a mobile subscriber to a previously designated URL address, a certain server address, or another mobile station. This is accomplished by setting up a supplementary function and subscribing to a call forwarding service. According to one embodiment, the method includes determining whether a corresponding called subscriber subscribes to a call forwarding service and setting up call forwarding unconditional functions by retrieving subscriber information, if routing information is requested according to packet call set-up request. Then, the packet call is set up for all packet calls directed to an IP address of the called subscriber and forwarded to a forward-to address, based on routing information generated by the result of the determining step. Incoming packet calls may therefore be forwarded and automatically routed to a commercial home page.

### BACKGROUND OF THE INVENTION

1. Field of the Invention

The present invention relates to a communications system, and more particularly a system and method for forwarding packet calls in mobile communication system.

2. Background of the Related Art

FIG. 1 shows a next-generation General Packet Radio Service (GPRS), which is expected to include a Mobile Station (MS) 1, Radio Network Controller (RNC) 2, Home Location Register (HLR) 3, Servicing GPRS Support Node (SGSN) 4, Gateway GPRS Service Node (GGSN) 5, and internet network 6.

The RNC is a wireless network control system and the HLR is a database which manages mobile subscribers, stores all subscriber information, and manages location information (circuit/packet) for incoming call routing.

The SGSN is a GPRS support system which is operated with the RNC by an Iu interface. Also, the SGSN operates with the GGSN by a Gn interface and supports GPRS service of the MS.

The GGSN operates with a packet switched network along with the SGSN using an IP backbone by the Gn interface. The GGSN supports packet data service between the MS and the packet switching network.

The RNC operates with the SGSN using an IP backbone by the Iu interface and supports packet data service between the MS and the packet network. The Iu interface is an interface between the RNC and the core network and the Gn interface is an interface between SGSN and GGSN in same carrier network.

FIG. 2 shows signal flows of a related-art method for setting up packet calls in a mobile communication. In an initial step, if the GGSN receives Packet Data Protocol Packet Data Unit (PDP PDU) from the internet network 6, the GGSN extracts a subscriber identification number International Mobile Subscriber Identity, IMSI) for the corresponding mobile subscriber from a destination IP address included with the received packet data. Then, a routing information request message is transmitted to the HLR 3, requesting address of SGSN in which location of the subscriber is registered (S21).

The HLR 3 that received the routing information request message retrieves subscriber information of the mobile subscriber and transmits routing information including SGSN address information to the GGSN (S22).

The GGSN that received the touting information transmits a packet data receipt notification message to the SGSN 4, notifying that the GGSN received packet data from the internet network 6 (S23), thereby trying paging.

The SGSN that received the packet data receipt notification message checks status information about whether or not the mobile subscriber can answer and transmits a packet data receipt notification response message to the GGSN 5 (S24), thereby trying paging within Routing Area (RA).

A PDP context activation process (i.e., a process of setting up a packet call in the next-generation GPRS network) is performed by MS's response to the paging. As a result, wireless resources are set up between the MS 1 and the RNC 2, and a PDP context is generated among the RNC 2, the SGSN 4, and the GGSN 5. Further, a traffic path is set up and, thus, the mobile subscriber can transmit and receive packet data.

Notwithstanding the foregoing, a call forwarding service has been found to be a useful supplementary service for mobile subscribers. According to this call forwarding service, an incoming call for a mobile subscriber who subscribed to the call forwarding service is forwarded to a previously designated URL addresses, server addresses or other mobile stations.

There is a problem with the related-art system when it comes to providing call forwarding service. Specifically, when a packet call set-up request to a mobile station occurs from an internet network, a mobile subscriber cannot answer calls which he wants to answer with another mobile station, because the next-generation GPRS network does not support a call forwarding service that forwards incoming packet calls to another mobile station or another address.

### SUMMARY OF THE INVENTION

An object of the present invention is to solve the above-described problems of the related-art system.

Another object of the present invention is to provide a system and method which forwards incoming packet calls to previously designated URL addresses, certain server addresses, and/or other mobile stations. In accordance with at least one embodiment, this may be accomplished by performing call forwarding features and supplementary functions when an incoming packet call set-up request is received from an internet network in a next-generation mobile communication system.

In order to achieve one or more of the above objects, the subscriber subscribes to a call forwarding service and also sets up one or more supplementary functions which include, for example, forwarding all incoming calls directed to an IP address of the mobile subscriber unconditionally or forwarding incoming calls only when no response is received to paging.

More specifically, in accordance with one embodiment, the present invention provides a method of forwarding packet calls in mobile communication system by: determining whether a corresponding called subscriber subscribes to call forwarding service and sets up call forwarding unconditional functions by retrieving subscriber information, if routing information is requested according to packet call set-up request; and setting up packet call for all packet calls directed to IP address of the called subscriber and forwarded to forward-to address, according to routing information generated by the result of said determining.

The call forwarding service may be registered by adding parameter having forwarding information to packet service subscriber data transmitted from the HLR to the SGSN when the HLR changes the subscriber information stored in database of SGSN.

The step of determining whether the corresponding called subscriber subscribes to call forwarding service and sets up call forwarding unconditional functions is preferably performed at Home Location Register (HLR) that received called subscriber routing information request.

In a case where the called subscriber subscribes to call forwarding service and sets up call forwarding unconditional functions according to a result of said determining, the HLR preferably transmits first routing information, for setting up packet call for all packet calls directed to IP address of the called subscriber and forwarded to forward-to address, to a Gateway General Packet Radio Service (GPRS) Service Node (GGSN).

The first routing information may include forwarding information, in a case where the called subscriber subscribes to call forwarding service. The forwarding information may include forward-to IP address information and/or at least one of a previously designated URL address, a certain server address, and other mobile station addresses.

The step of setting up a packet call preferably includes: transmitting first routing information including forwarding information from HLR to GGSN; determining second HLR for setting up packet call forwarded to another mobile station by checking forwarding information from the received first routing information; and setting up packet call, forwarded to another mobile station registered by the called subscriber, according to the second routing information received from the second HLR.

The step of setting up a packet call further preferably includes: transmitting first routing information including forwarding information from HLR to GGSN and checking forwarding information from the received first routing information; and, in a case where setting up packet call forwarded to another mobile station is impossible according to a result of said checking, setting up forwarded packet call by routing the packet call using internet network according to the received forwarding information.

In accordance with another embodiment, the present invention provides a method of forwarding packet calls in mobile communication system by: receiving routing information of called subscriber according to packet call set-up request and trying paging a mobile handset of the called subscriber; and, in a case where there is no response to the paging, determining whether or not the called subscriber subscribes to call forwarding service and, then, stopping packet call set-up trial or setting up packet call for all packet calls directed to IP address of the called subscriber and forwarded to forward-to address.

The call forwarding service is preferably registered by adding parameter having forwarding information to packet service subscriber data transmitted from the HLR to the SGSN when the HLR changes the subscriber information stored in database of SGSN.

The step of determining whether or not the called subscriber subscribes to call forwarding service in a case where there is no response to the paging may be performed at an SGSN which tries to page a mobile handset of the called subscriber.

In a case where the called subscriber subscribes to a call forwarding service, the SGSN preferably transmits information including forwarding information for setting up packet call for all packet calls directed to IP address of the called subscriber and forwarded to forward-to address, to GGSN.

The information including forwarding information may include forward-to IP address information and/or at least one of previously designated URL addresses, certain server addresses and other mobile station addresses. The information including forwarding information may also include information indicating that no response occurred from the called subscriber, provided that the called subscriber subscribes to the call forwarding service.

The step of setting up a packet call for all packet calls directed to an IP address of the called subscriber and forwarded to a forward-to address includes: transmitting information including forwarding information from SGSN to GGSN according to a result of the SGSN's determination that the called subscriber subscribes to call forwarding service; and setting up packet call forwarded to another mobile station by checking forwarding information from the received information including forwarding information.

Alternatively, the step of setting up a packet call for all packet calls directed to an IP address of the called subscriber and forwarded to a forward-to address includes: transmitting information including forwarding information from SGSN to GGSN according to a result of the SGSN's determination that the called subscriber subscribes to call forwarding service; checking forwarding information from the received information including forwarding information; and, in a case where setting up packet call forwarded to another mobile station is impossible as a result of said checking, setting up the forwarded packet call by routing the packet call using internet network according to the received forwarding information.

### BRIEF DESCRIPTION OF THE DRAWINGS

FIG. 1 illustrates a related-art next-generation GPRS network.

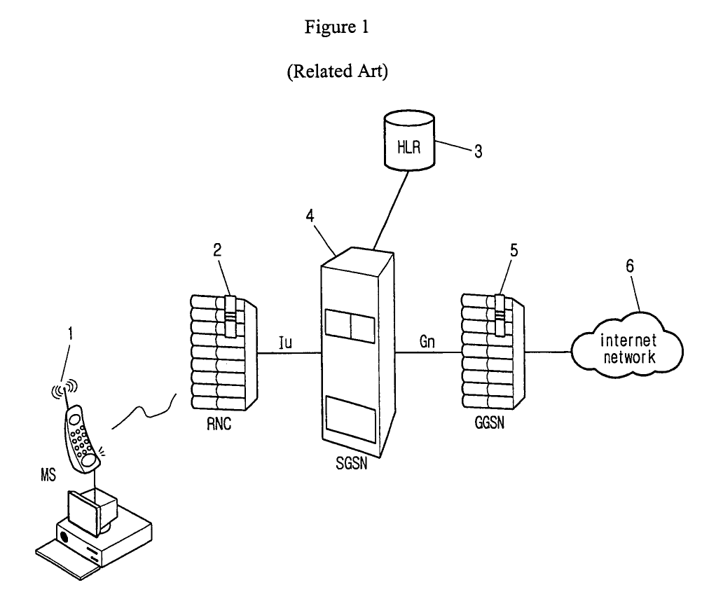

FIG. 2 illustrates a method of setting up a packet call in a related-art mobile communication system.

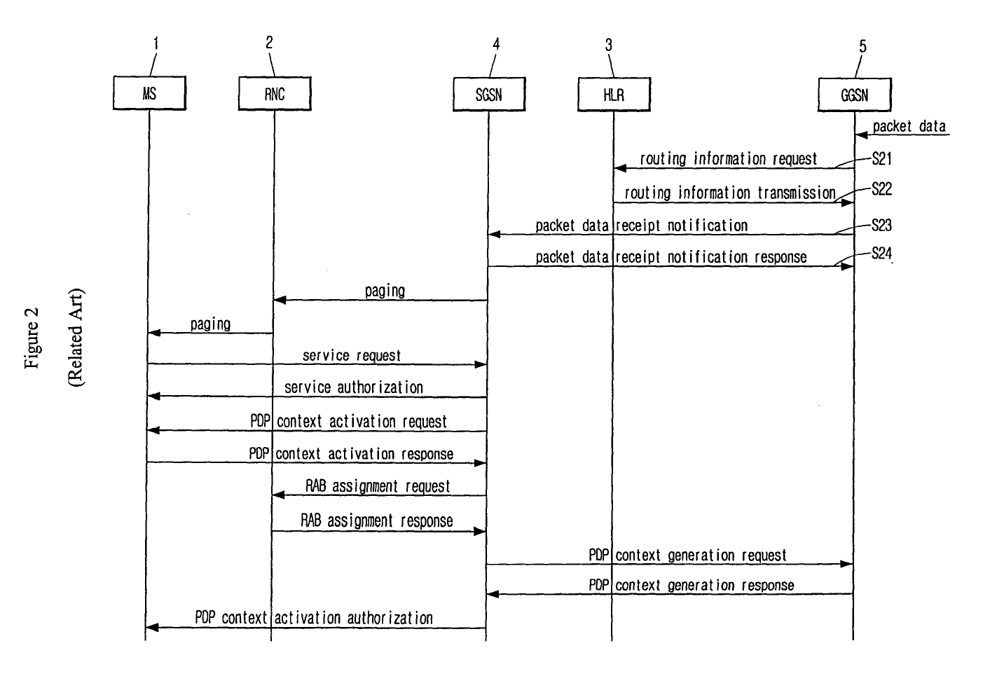

FIG. 3 illustrates a GPRS network according to one embodiment of the present invention.

FIG. 4 is a flowchart showing steps performed when call forwarding unconditional functions are set up according to a preferred embodiment of the method of the present invention.

FIG. 5 illustrates signal flows performed when call-forwarding unconditional functions are set up according to the preferred embodiment of the method of the present invention.

FIG. 6 is a flow chart showing steps performed when supplementary functions of forwarding an incoming packet call only when there is no response from a subscriber to paging are set up according to the preferred embodiment of the method of the present invention.

FIG. 7 illustrates signal flows performed when supplementary functions of forwarding incoming packet call only when there is no response from subscriber to paging are set up according to the preferred embodiment of the method of the present invention.

FIG. 8 illustrates signal flows performed when mobile subscriber location is registered according to the preferred embodiment of the method of the present invention.

### DETAILED DESCRIPTION OF PREFERRED EMBODIMENTS

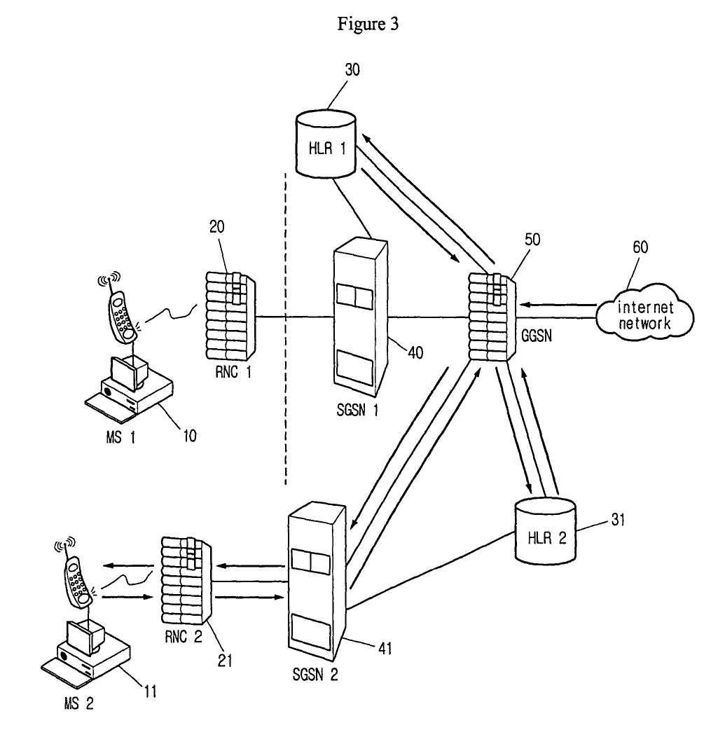

FIG. 3 shows a next-generation GPRS network according to a preferred embodiment of the present invention. The next generation GPRS network includes a Mobile Station (MS 1) 10, a Mobile Station (MS 2) 11, a Radio Network Controller (RNC 1) 20, A Radio Network Controller (RNC 2) 21, a Home Location Register (HLR 1) 30, a Home Location Register (HLR 2) 31, an SGSN 1 (40), an SGSN 2 (41), a GGSN 50, and an internet network 60. In this embodiment, it may be assumed that a called subscriber subscribes to a call-forwarding service and, preferably at the same time, sets up one or more supplementary functions such as call-forwarding functions for forwarding all packet calls directed to the subscriber's IP address unconditionally and forwarding packet calls only when there is no response to paging. Also, in a case where the call-forwarding service is subscribed to, it is possible to set up to forward incoming packet calls to one or more previously designated URL addresses, certain server addresses or other mobile stations.

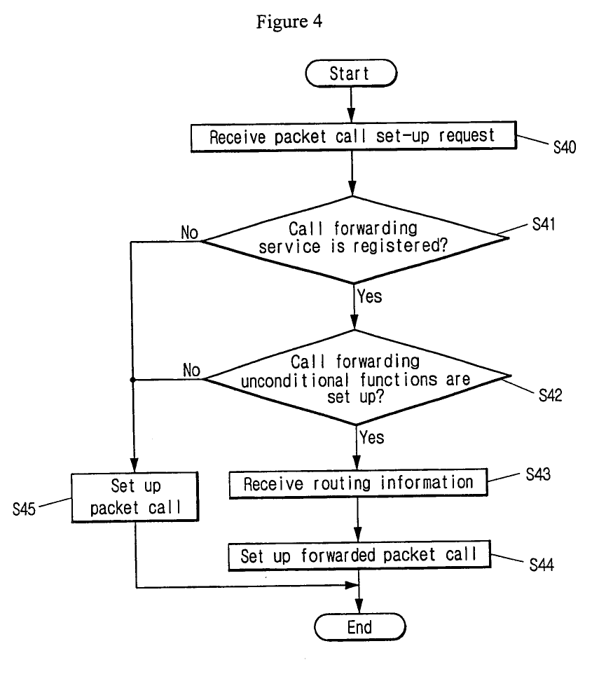

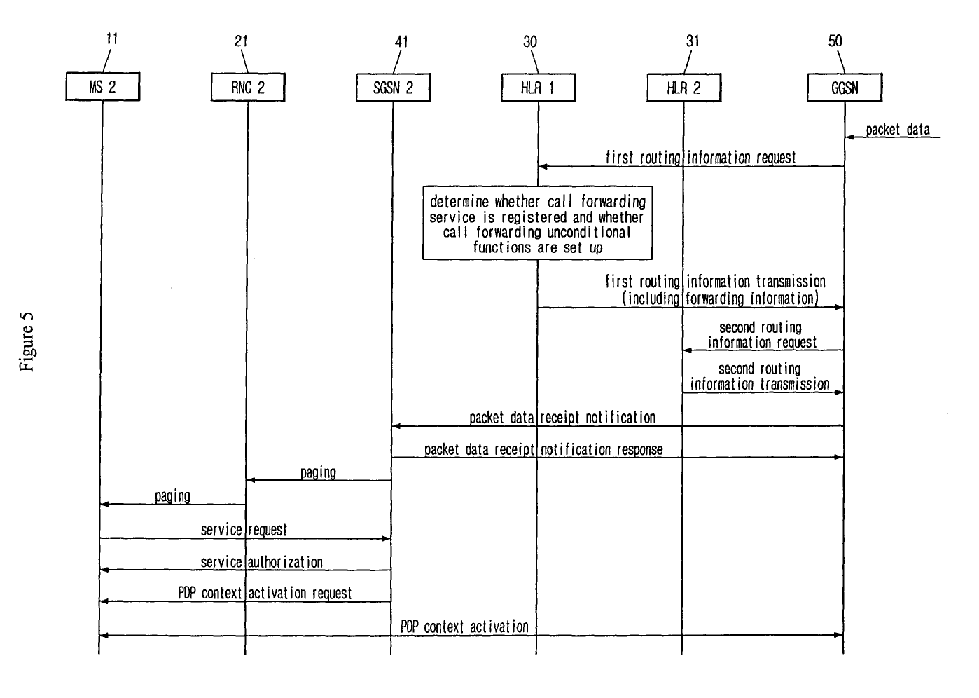

FIGS. 4 and 5 show steps performed by an embodiment of the invention when a called subscriber that subscribes to a call-forwarding service sets up a supplementary function of forwarding all packet calls directed to the called subscriber unconditionally.

Initially, when a packet call set-up request occurs from internet network 60, GGSN 50 receives a Packet Data Protocol (PDP) Packet Data Unit (PDU) from the internet network (S40).

The GGSN extracts a destination IP address from the received PDP PDU and obtains an International Mobile Subscriber Identity (IMSI) from the extracted destination IP address. Because the GGSN manages IMSI information according to an IP address, it is possible to obtain the IMSI from the extracted destination IP address.

The GGSN then requests an address of a SGSN, where the called subscriber location is registered, by transmitting a first routing information request message to HLR 1 (30).

When HLR 1 receives the first routing information request message from the GGSN, HLR 1 checks the IMSI and subscriber status through the received first routing information request message.

HLR 1 then determines whether a call-forwarding service is registered in the subscriber information by retrieving information from a subscriber database (S41), and in a case where call-forwarding service is registered determines whether call-forwarding unconditional functions are set up (S42).

As a result of determining step S42, in a case where the called subscriber has set up call-forwarding unconditional functions, HLR 1 transmits the first routing information including forwarding information to the GGSN and the GGSN proceeds with a set-up procedure of forwarded packet call according to the received forwarding information (S43, S44). The forwarding information preferably includes forward-to IP address information, HLR 1 changes an information element related to the first routing information by adding a parameter having the forwarding information to the information element related to the first routing information, and transmits the first routing information to the GGSN.

At steps S41 and S42, in a case where the called subscriber does not subscribe to a call-forwarding service or in a case where the called subscriber does not set up call-forwarding unconditional functions, even though the called subscriber subscribes to call forwarding service, the first routing information does not include forwarding information.

Accordingly, the GGSN notifies the SGSN of a location where the called subscriber is registered hereinafter, SGSN 1 (40)) of packet data receipt according to the first routing information and, thus, the SGSN 1 (40) proceeds with paging within a certain Routing Area (RA) and a PDP context activation procedure (that is, a procedure of setting up a packet call in the next-generation GPRS network) (S45).

Assuming that MS 2 (11) is registered as forward-to mobile station, the GGSN determines whether to receive the first routing information from the HLR 1, and in a case where the GGSN receives the first routing information the GGSN determines whether forwarding information is included in the first routing information received from the HLR 1.

In a case where forwarding information is included in the first routing information received from the HLR 1 as a result of the determining step, the GGSN checks the forwarding information.

In a case where the forwarding information includes a forward-to IP address as a result of the checking step, the GGSN obtains IMSI according to the forward-to IP address and determines HLR 2 (31) for setting up the forwarded packet call. The GGSN requests an address of SGSN where a location of the called subscriber is registered (hereinafter, SGSN2 41) by transmitting a second routing information request message.

In a case where the destination IP address is one from which IMSI cannot be obtained and this destination IP address is included in the received forwarding information, the GGSN may perform a role of a router by routing the packet call using the internet network 60.

An IP address which cannot be obtained from IMSI may be an IP address which is not included in mobile communication network as a result of determining whether the destination IP address is included in mobile communication network or in internet network 60 with reference to database of the GGSN. Thus, an incoming packet call may be forwarded to a previously designated URL addresses, server addresses or etc.

HLR 2 (31) that received the second routing information request message checks the IMSI of the called subscriber and the subscriber status through the received second routing information, and then transmits the second routing information including an SGSN address, where the location of the subscriber is registered, to the GGSN 50.

The GGSN 50 receives the second routing information from the HLR 2 (31) and transmits a packet data receipt notification message, notifying that packet data has been received from internet network 60, to SGSN 2 (41) newly determined for the forward-to IP address.

The SGSN 2 (41) checks status information about whether the subscriber can answer, generates a packet data receipt notification response message, and then transmits the packet data receipt notification response message to the GGSN 50.

The SGSN 2 (41) then performs paging within a certain Routing Area (RA), and MS 2 (11) responds to the paging, thereby performing a PDP context activation procedure. In other words, wireless resources are set up between the MS 2 (11) and RNC 2 (21), and among the RNC 2 (21), SGSN 2 (41) and GGSN 50 a PDP context is generated and a traffic path is set up. The subscriber can therefore transmit and receive packet data.

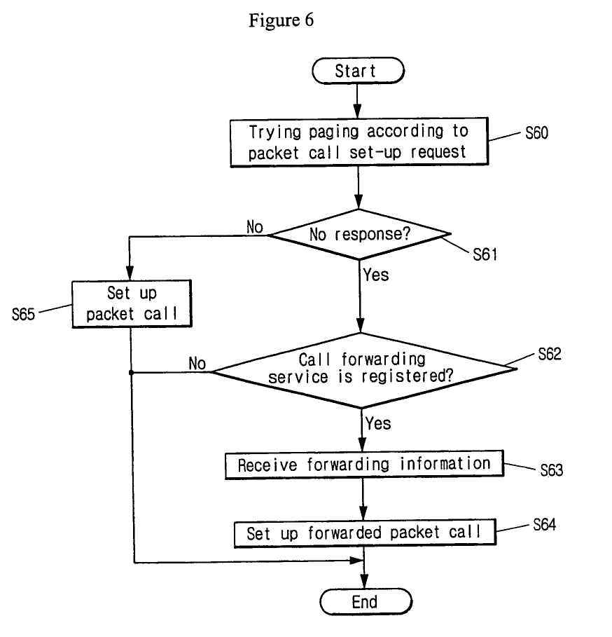

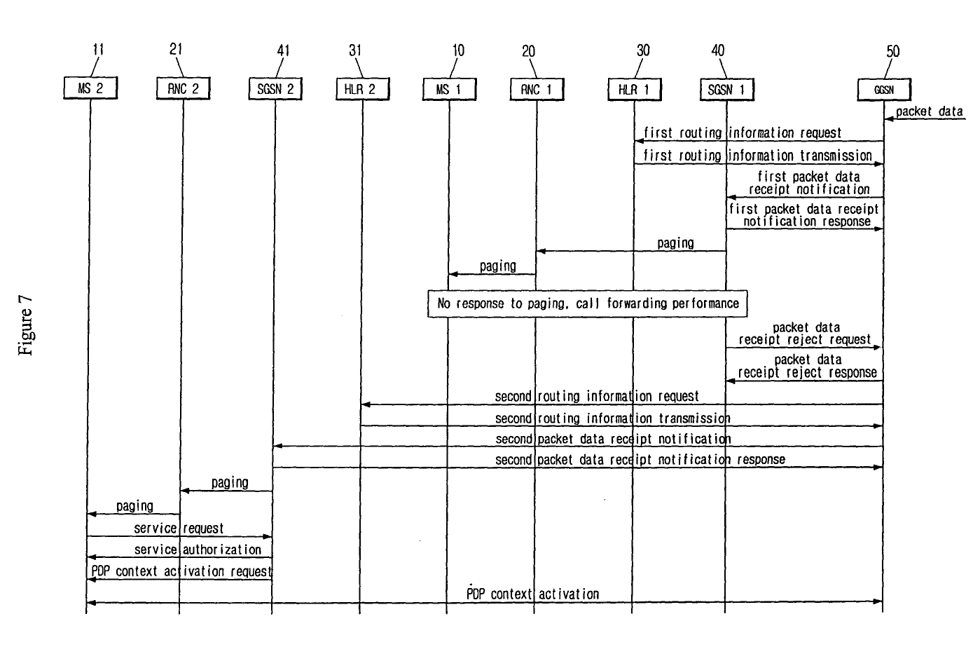

FIGS. 6 and 7 show steps performed in a case where the subscriber sets up supplementary functions of forwarding a packet call only to a called subscriber who subscribes to a call forwarding service but cannot answer.

If GGSN 50 receives packet data from internet network 60, the GGSN obtains IMSI from a destination IP address extracted from the received packet data and requests an SGSN address of the called subscriber to HLR 1 (30). Then, the GGSN transmits a first packet data receipt notification message, notifying that the GGSN has received packet data from the internet network 60, to SGSN 1 (40) corresponding to the received SGSN address.

The SGSN 1 (40) that received the first packet data receipt notification message determines whether the called subscriber can receive the packet data. In a case where the called subscriber can receive the packet data, the SGSN 1 notifies the GGSN of PDP context activation by transmitting the first packet data receipt notification response message to the GGSN.

Then, the SGSN 1 (40) tries paging according to a packet call set-up request (S60). More specifically, the SGSN 1 (40) performs paging to the RNC 1 (20) and the RNC 1 (20) performs paging to MS 1 (10).

If a response to paging is not received from the MS 1 (10) within a certain time (S61), the SGSN 1 (40) regards status of the MS 1 (10) as “No Response Status” and checks whether the called subscriber has subscribed to a call-forwarding service by retrieving subscriber information data from subscriber database in SGSN 1 40 (S62). In other words, if there is no response from MS 1 (10) to paging and the called subscriber is determined to be a subscriber to call-forwarding service, SGSN 1 (40) transmits a packet data receipt reject request message, including information indicating a “Subscriber No Response” and forwarding information, to the GGSN 50.

The forwarding information preferably includes forward-to IP address (for example, a URL address, a certain server address or another mobile station address) and the packet data receipt reject request message, whose changed information element is transmitted to the GGSN 50 by adding the forwarding information to information element of the packet data receipt reject request message.

GGSN 50 that received the forwarding information included in the packet data receipt reject request message proceeds with procedure of setting up forwarded packet call (S63, S64). In other words, GGSN 50 receives the packet data receipt reject request message and transmits packet data receipt reject response message to the SGSN 1 (40). Then, GGSN 50 checks whether the forwarding information is included in the packet data receipt reject request message. In a case where the forwarding information is included, the GGSN obtains IMSI corresponding to destination IP address.

The GGSN 50 requests the SGSN address, corresponding to a location where the called subscriber is registered, by transmitting a second routing information request message to HLR 2 (31) according to the obtained IMSI.

In a case where the destination IP address is one from which IMSI cannot be obtained, the GGSN 50 may perform the role of a router by routing the packet call using internet network 60. In other words, a destination IP address from which IMSI cannot be obtained may be an IP address which is not included in the mobile communication network, which may be determined based on whether the destination IP address is one included in mobile communication network or in internet network 60 with reference to database of the GGSN 50.

HLR 2 (31), that received the second routing information request message from the GGSN 50, checks IMSI of the called subscriber and the subscriber status through the received second routing information request message and transmits the second routing information including SGSN address, where location of the subscriber is registered, to GGSN 50.

The GGSN 50 then receives the second routing information from the HLR 2 (31) and transmits packet data receipt notification message, notifying that packet data has been received from internet network 60, to SGSN 2 (41) newly determined for a forward-to IP address.

The SGSN 2 (41) checks status information about whether the called subscriber can answer. In a case where the called subscriber can answer, SGSN 2 (41) generates a packet data receipt notification response message and transmits the packet data receipt notification response message to the GGSN 50. Then, SGSN 2 (41) performs paging to the RNC 2 (21) and the RNC 2 (21) performs paging to MS 2 (11). MS 2 (11) responds to paging, thereby performing context activation procedure. Thus, wireless resources are set up between the MS 2 (11) and the RNC 2 (21).

Among the RNC 2 (21), SGSN 2 (41) and GGSN 50, a PDP context is generated and a traffic path is set up. Thus, the called subscriber transmits and receives packet data.

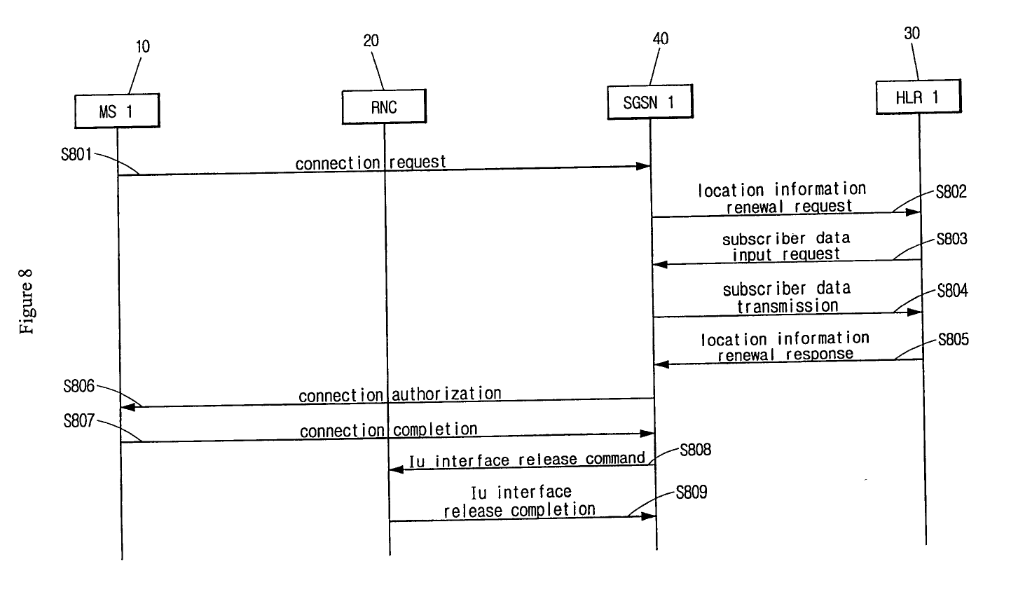

FIG. 8 shows operations performed when a mobile subscriber location is registered in a mobile communication system.

MS 1 (10) transmits a connection request message to SGSN 1 (40) in order to register its own location, thereby starting registration of the mobile subscriber's location (S801).

SGSN 1 (40) transmits a location information renewal request message to HLR 1 (30) (S802), and HLR 1 transmits a subscriber data input request message, that includes packet service subscriber data and requests subscriber data input, to the SGSN 1 (40) (S803).

SGSN 1 (40), that received the subscriber data input request message, stores the received packet service subscriber data in a database of the SGSN 1 (40) and, then, responds to the subscriber data input request message (S804).

HLR 1 (30) renews corresponding subscriber location information stored in the database of the HLR 1 (30) and then transmits a location information renewal response message to SGSN 1 (40) (S805).

In order to register a call-forwarding service, when HLR 1 changes the subscriber information stored in the database of the SGSN 1 (40), HLR 1 (30) adds a parameter having forwarding information to packet service subscriber data included in a subscriber data input request message transmitted to the SGSN 1 (40). Then, SGSN 1 (40) transmits a connection authorization message to the MS 1 (10) and the MS 1 (10) transmits connection completion message to the SGSN 40 (S807).

Then, SGSN 1 (40) transmits an Iu interface release command message to the RNC 1 (20) (S808) and RNC 1 (20) transmits an Iu interface release completion message to SGSN 1 (40), thereby completing registration of subscriber location (S809).

The foregoing embodiments and advantages are merely exemplary and are not to be construed as limiting the present invention. The present teaching can be readily applied to other types of methods. The description of the present invention is intended to be illustrative, and not to limit the scope of the claims. Many alternatives, modifications and variations will be apparent to those skilled in the art.

According to the present invention, a mobile subscriber sets up one or more supplementary functions of forwarding all calls directed to an IP address of the mobile subscriber unconditionally and forwarding calls only when there is no response to paging. Thus, incoming packet calls are forwarded to a previously designated URL address, certain server address, or another mobile station, which thereby automatically routes the packet call to a commercial home page.

What is claimed is:

1. A method of forwarding packet calls in mobile communication system, comprising:
determining whether a called subscriber is a subscriber of a call-forwarding service and has set up a call-forwarding unconditional function in response to a packet call set-up request; and
setting up a packet call directed to an IP address of the called subscriber for forwarding to a forward-to address based on a result of said determining step.

2. The method of claim 1, further comprising: registering the call forwarding service by adding a parameter having forwarding information to packet service subscriber data transmitted from an HLR to an SGSN when the HLR changes the subscriber information stored in a database of the SGSN.

3. The method of claim 1, wherein the determining step is performed at an HLR that received a called subscriber routing information request.

4. The method of claim 1, further comprising when the called subscriber is determined to have subscribed to the call forwarding service and set up the call-forwarding unconditional function: transmitting from an HLR to a Gateway General Packet Radio Service (GPRS) Service Node (GGSN) first routing information for setting up the packet call directed to the IP address of the called subscriber and forwarded to the forward-to address.

5. The method of claim 4, wherein the first routing information includes forwarding information, in a case where the called subscriber subscribes to the call forwarding service.

6. The method of claim 2, wherein the forwarding information includes forward-to IP address information.

7. The method of claim 5, wherein the forwarding information includes forward-to IP address information.

8. The method of claim 2, wherein the forwarding information includes at least one of a previously designated URL address, a certain server address and another mobile station address.

9. The method of claim 5, wherein the forwarding information includes at least one of a previously designated URL address, a certain server address, and another mobile station address.

10. The method of claim 1, wherein the setting up step comprises:
transmitting first routing information including forwarding information from a first HLR to a GGSN;
determining a second HLR for setting up the packet call forwarded to another mobile station by checking forwarding information from the received first routing information; and
setting up the packet call, forwarded to another mobile station registered by the called subscriber, according to second routing information received from the second HLR.

11. The method of claim 1, wherein the setting up step comprises:
transmitting first routing information including forwarding information from a first HLR to a GGSN; and
checking forwarding information from the received first routing information, wherein in a case where setting up the packet call forwarded to another mobile station is impossible according to a result of said checking step, setting up a forwarded packet call by routing the packet call using an internet network according to the received forwarding information.

12. A method of forwarding packet calls in mobile communication system, comprising:
receiving routing information of a called subscriber according to a packet call set-up request; and
paging a mobile handset of the called subscriber; wherein when no response is received from dais paging, determining whether the called subscriber subscribes to a call forwarding service and then either stopping a packet call set-up trial or setting up a packet call directed to an IP address of the called subscriber and forwarded to a forward-to address.

13. The method of claim 12, further comprising: registering the call forwarding service by adding parameter having forwarding information to packet service subscriber data transmitted from an HLR to an SGSN when the HLR changes the subscriber information stored in a database of SGSN.

14. The method of claim 12, wherein the determining step is performed at an SGSN which pages a mobile handset of the called subscriber.

15. The method of claim 12, wherein when the called subscriber subscribes to the call forwarding service, an SGSN transmits to a GGSN information including forwarding information for setting up a packet call directed to an IP address of the called subscriber and forwarded to forward-to address.

16. The method of claim 15, wherein the information including forwarding information includes a forward-to IP address information.

17. The method of claim 15, wherein the information including forwarding information includes at least one of a previously designated URL address, a certain server address, and another mobile station address.

18. The method of claim 15, wherein the information including forwarding information comprises information indicating that there is no response from the called subscriber, when the called subscriber is a subscriber of the call forwarding service.

19. The method of claim 12, wherein the setting up step comprises:
transmitting information including forwarding information from an SGSN to a GGSN according to a result of the determination step; and
setting up a packet call forwarded to another mobile station by checking forwarding information from the received information including forwarding information.

20. The method of claim 12, wherein the setting up step comprises:
transmitting information including forwarding information from an SGSN to a GGSN according to a result of the determining step; and
checking forwarding information from the received information including forwarding information; wherein
in a case where setting up a packet call forwarded to another mobile station is impossible as determined from a result of the checking step, setting up the forwarded packet call by routing the packet call using an internet network according to the received forwarding information.

21. A method for processing calls in a mobile communications system, comprising:
receiving a call directed to an IP address of a mobile terminal subscriber; and
forwarding the call to a forwarding address of the mobile terminal subscriber.

22. The method of claim 21, wherein the forwarding address is a different IP address of the mobile terminal subscriber.

23. The method of claim 21, wherein the forwarding address is one of a predetermined URL address, a predetermined server address, or an address corresponding to another mobile terminal.

24. The method of claim 21, wherein the forwarding step is performed unconditionally.

25. The method of claim 21, further comprising:
sending a paging signal the mobile subscriber terminal,
wherein the forwarding step is performed only when no response is received from the paging signal.

26. The method of claim 21, further comprising:
determining whether the mobile terminal subscriber is a subscriber of a call-forwarding service, wherein the forwarding step is performed based on a result of the determining step.

27. The method of claim 26, further comprising:
determining a type of call-forwarding service of the mobile terminal subscriber; and
forwarding the call based on the type of call-forwarding service.

28. The method of claim 27, wherein the type of call-forwarding service is one where calls are unconditionally forwarded to the forwarding address.

29. The method of claim 28, wherein the type of call-forwarding service is one where calls are forwarded to the forwarding address after no response has been received from a paging signal for a predetermined period of time.

30. A system for managing calls in a mobile communications system, comprising:
a receiving unit which receives information indicating that a call directed to an IP address of a mobile terminal subscriber has been received; and
a control system which forwards the call to a forwarding address of the mobile terminal subscriber.

31. The system of claim 30, wherein the forwarding address is a different IP address of the mobile terminal subscriber.

32. The system of claim 30, wherein the forwarding address is one of a predetermined URL address, a predetermined server address, or an address corresponding to another mobile terminal.

33. The system of claim 30, wherein the forwarding step is performed unconditionally.

34. The system of claim 30, further comprising:
a paging unit which sends a paging signal the mobile subscriber terminal, wherein the control system forwards the call to the forwarding address only when no response is received from the paging signal.

35. The system of claim 30, wherein the control system determines whether the mobile terminal subscriber is a subscriber of a call-forwarding service and forwards the call based on a result of the determination.

36. The system of claim 35, wherein the control system determines a type of call-forwarding service of the mobile terminal subscriber and forwards the call based on the type of call-forwarding service.

37. The system of claim 36, wherein the type of call-forwarding service is one where calls are unconditionally forwarded to the forwarding address.

38. The system of claim 37, wherein the type of call-forwarding service is one where calls are forwarded to the forwarding address after no response has been received from a paging signal for a predetermined period of time.
